(19) United States
(12) Patent Application Publication
(10) Pub. No.: US 2022/0036154 A1
(43) Pub. Date: Feb. 3, 2022

(54) UNSUPERVISED MULTI-DIMENSIONAL COMPUTER-GENERATED LOG DATA ANOMALY DETECTION

(71) Applicant: International Business Machines Corporation, Armonk, NY (US)

(72) Inventor: Dinesh Babu Yeddu, Guntur (IN)

(21) Appl. No.: 16/942,780

(22) Filed: Jul. 30, 2020

(51) Int. Cl. G06N 3/04; G06N 3/08

(52) U.S. Cl. CPC G06N 3/0445; G06N 3/08

(57) ABSTRACT

A computer receives a stream of discrete log data entries containing at least one unique entry, for the computer to identify anomalies in machine log data. The computer generates a log data sentiment analyzer with a lexicon customized to identify a tone of content for each of said log data entries. The computer assigns a unique message ID to the unique messages and collects data attributes of the unique entries. For each unique entry, the computer identifies an entry tone or sentiment and at least one additional unique entry attribute. The computer generates a time series analysis of the identified entry sentiment and the additional attributes and conducts statistical analysis of the attributes using at least one deep learning analysis model to identify historical anomalies in the log data attributes, using the identified anomalies indicate trouble in a system associated with the collected log data.

### BACKGROUND

The present invention relates generally to the field of computer-generated log data analysis and, more specifically, to unsupervised anomaly detection based on time series analysis of log data.

Many machines communicating with computers produce activity logs containing diagnostic data. Mining this data to identify indications of abnormal machine behavior can reveal system trouble, as well as underlying causes for the trouble. Increased use of machines in automation and digitalization has led to an ever-increasing volume of machine activity log data, and approaches to process this data efficiently are needed to make meaningful use of this source of operation insight.

One way to use log data is to compare current machine behavior to historical patterns of behavior to find instances, often referred to as anomalies, where current behavior differs significantly from expected behavior. As the volume and input pace of available log data increases, computers are used more and more to look for these anomalies. Successful log data anomaly detection is important, because it provides valuable insight about machine behavior and allows support teams to identify possible performance issues for monitored machines. With this information, system performance may be analyzed, root causes of potential problems may be identified, and system troubles may be addressed before outages occur.

Some issues with log data analysis include difficulty in properly classifying and clustering log messages for use with supervised machine learning techniques, as the associated manual labelling of large amounts of log data is time and resource intensive. Other issues include finding optimized windows lengths for use in computerized deep learning techniques, since these methods typically require a data analyst to predict an optimum window size, and determining an accurate window often requires multiple rounds of iterative testing. Deep learning methods can have other issues as well, including the need for prohibitively-large amounts of training data and processing time. Still other log anomaly detection approaches use dynamic models that can require unwieldy, contextual evolution methods to identify log entries that do not follow (i.e., are outside historically-typical clusters) expected appearance patterns for measured aspects of gathered log data.

### SUMMARY

The present disclosure recognizes the shortcomings and problems associated with typical log data anomaly detection approaches, especially in unsupervised methods of log data analysis. Aspects of the present invention include log-data-specific analysis of message semantics to accurately determine underlying meanings of machine operation log data messages. Other aspects of the invention include holistic data analysis that considers multiple combinations of key performance indicators, including overall frequency of duplicated message content, overall time spacing between duplicated message content, and the frequency of appearance of various message types.

In embodiments according to the present invention, a computer-implemented method includes a computer that receives a group or stream of discrete log data entries with at least one unique entry. The computer generates a log data sentiment analyzer with a lexicon customized to identify a tone of content for each of the log data entries. The computer assigns a unique message ID the unique messages in the discrete log data. The computer collects attributes of the unique entries, identifying for each unique entry, an entry sentiment and at least one additional unique entry attribute. The additional attributes may include time differences between occurrences of said unique message, and frequency of messages having a predetermined category. The computer identifies an analysis time window and conducts a time series analysis for message sentiment and additional, message attribute. The computer conducts statistical analysis of the time series information using at least one deep learning analysis model to identify historical anomalies in said log data attributes. The identified anomalies indicate trouble associated with said log data, and the computer uses this identification to prepare appropriate notifications.

In another embodiment of the invention, a system to optimize input component enablement comprises: a computer system comprising a computer readable storage medium . . . system for identifying anomalies in log data which comprises a computer system comprising a computer readable storage medium having program instructions embodied therewith, the program instructions executable by a computer to cause the computer to: receive a plurality of discrete log data entries, said plurality having at least one unique entry; generate a log data sentiment analyzer having a lexicon customized to identify a tone of content for each of said log data entries; assign a unique message ID to said at least one unique message; collect data attributes of said at least one unique entry, said attributes identifying, for each unique entry, an entry sentiment and at least one additional unique entry attribute; and conduct statistical analysis of said collected data attributes using at least one deep learning analysis model to identify historical anomalies in said log data attributes, wherein said identified anomalies indicate trouble associated with said log data.

In another embodiment of the invention, a computer program product . . to identify anomalies in log data, the computer program product comprising a computer readable storage medium having program instructions embodied therewith, the program instructions executable by a computer to cause the computer to: receive a plurality of discrete log data entries, said plurality having at least one unique entry; generate a log data sentiment analyzer having a lexicon customized to identify a tone of content for each of said log data entries; assign a unique message ID to said at least one unique message; collect data attributes of said at least one unique entry, said attributes identifying, for each unique entry, an entry sentiment and at least one additional unique entry attribute; and conduct statistical analysis of said collected data attributes using at least one deep learning analysis model to identify historical anomalies in said log data attributes, wherein said identified anomalies indicate trouble associated with said log data.

Aspects of the invention provide perspective regarding system issues that might be developing but which have not yet caused an outage. Aspects of the invention deliver complementary, multi-dimensional KPI trend information, allowing problems to be identified in a predictive, holistic, manner rather than merely waiting for a single to factor to indicate failure or show why failure has already occurred. Aspects of the present invention also provide diagnostic information useful when no single factor provides a root cause for failure.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth below.

FIG.1 is a schematic block diagram illustrating an overview of a system for computer-implemented, multidimensional log data anomaly identification according to embodiments of the present invention.

FIG. 2 is a table showing a sample twenty-minute block of unprocessed log data from a log data stream schematically represented in FIG.1 that is ready for pre-processing.

FIG. 3 is a table including a version of the log data shown in FIG. 2 after undergoing pre-processing by part of the system shown in FIG. 1.

FIG. 4 is a flowchart illustrating a method, implemented using the system shown in FIG. 1, of multidimensional log data anomaly identification according to aspects of the invention.

FIG. 5 is a table showing unique log messages each indexed by ID and having associated sentiment and category attributes assigned according to aspects of the invention from the method shown in FIG. 2.

FIG. 6 is a table showing the unique log message attributes from the table in FIG. 5 merged into the processed log data from in FIG. 3 to generate a complete table of the log data shown in FIG. 3 with message ID, sentiment, and category attributes assigned to each log data entry according to aspects of the invention from the method shown in FIG. 2.

FIG. 7 is a schematic block diagram illustrating aspects of the multi-dimensional historical norm determination module from FIG. 4.

FIG. 8 is a table showing frequency metadata for each of 4 unique log data ID values present in the complete table of log data shown in FIG. 6 according to aspects of the invention from the method shown in FIG. 2.

FIG. 9 is a table showing frequency metadata for each of 3 unique log data categories present in the complete table of log data shown in FIG. 6 according to aspects of the invention from the method shown in FIG. 2.

FIG. 10 is a table showing recency (i.e., time difference) metadata for each of 4 unique log data ID values present in the complete table of log data shown in FIG. 6 according to aspects of the invention from the method shown in FIG. 2.

FIG. 11 is a flowchart illustrating aspects of the statistical analysis and anomaly identification module from FIG. 4.

FIG. 12 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 13 depicts a cloud computing environment according to an embodiment of the present invention.

FIG. 14 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

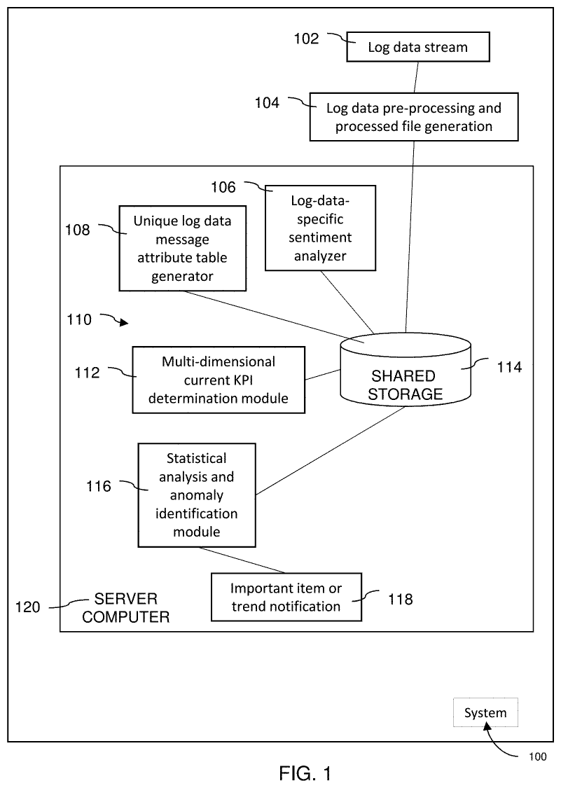

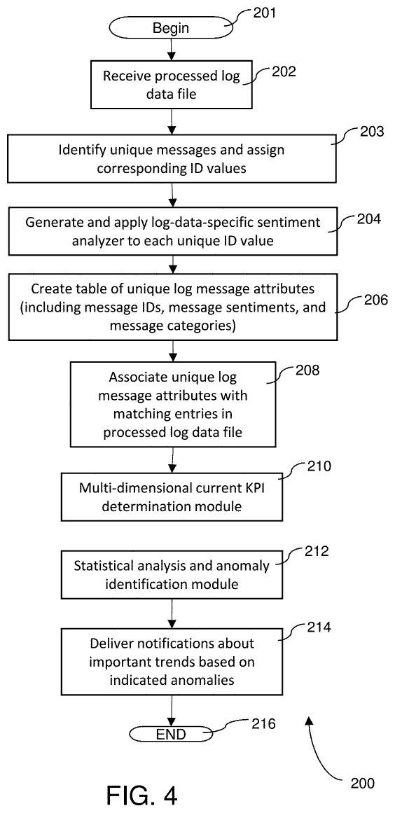

Now with combined reference to the Figures generally and with particular reference to FIGS. 1 and 4, an overview of a method 200 of multidimensional, unsupervised log data anomaly detection usable within a system 100 as carried out by a server computer 120 having optionally shared storage 114 and aspects 110 that optimize log data analysis and anomaly detection, according to an embodiment of the present disclosure is shown.

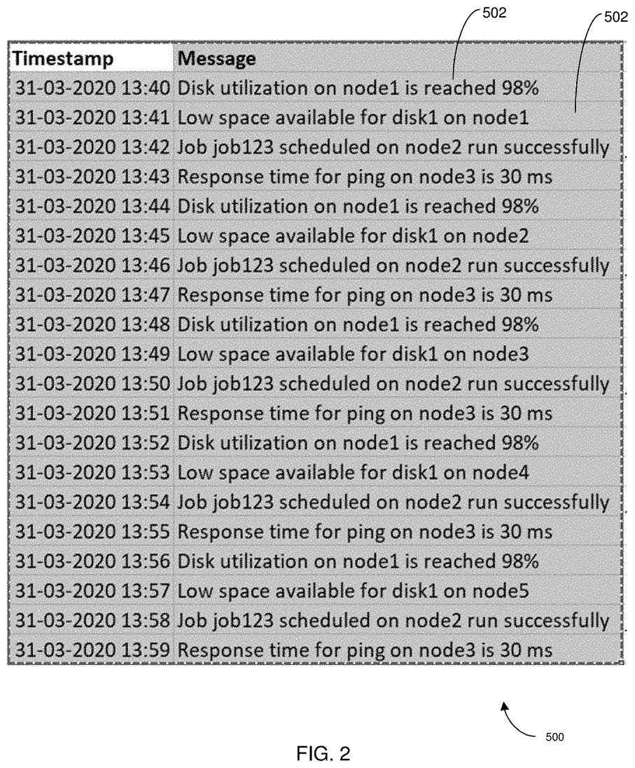

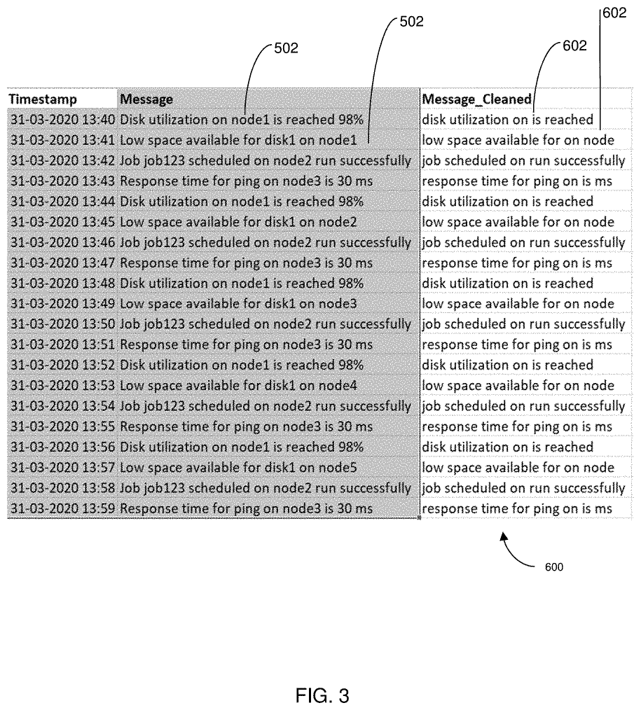

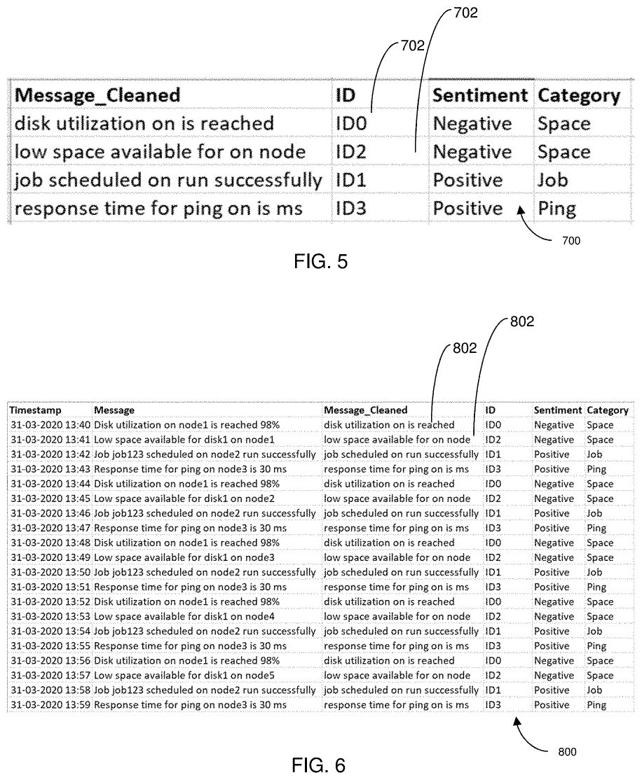

In FIG. 1 a stream 102 of activity log data is received by log data pre-processing and processed file generation element shown schematically at block 104. Now with additional reference to FIG. 2, a twenty-minute window of unprocessed log data 500 is shown, and the elements in block 104 remove unwanted characters from entries 502 of the log data. More particularly, message text is converted to lower case text, variable parts including the names of various applications, job, and servers and so on are removed. The entries are parsed, with additional reference to block 203 of FIG. 4, into distinct, compact message entries shown as elements 602 in FIG. 3. The system 100 also includes a log-data-specific sentiment analyzer 106 which generates a customized analysis lexicon based on the log data message content, so that the analyzer can detect message content tone for each unique message in the logged data. With continued reference to FIG. 4, sentiment analysis is applied to each of the unique messages in the log data, in accordance with the customized lexicon (from 106), to identify the message sentiment of each unique message. In this way, the server computer 120 assigns a positive, neutral, or negative sentiment to the messages 702 as shown in FIG. 5. In addition to the sentiments listed above, it is noted that fuzzy logic sentiments (e.g., highly positive, positive, neutral, negative, highly negative) may also be attributed, in accordance with the judgment of one skilled in this art. As will be described more fully below, a unique log data message attribute table generator at element 108 produces tables of data with various ID, sentiment, and category attributes assigned to the log data messages 602. A multi-dimensional current KPI determination module 112, which will be described more fully below, conducts time series analysis of the various attributes assigned to the log data entries 602 to determine key performance indicators for selected intervals of time within the data stream. According to other aspects of the invention, the system also includes a statistical analysis and anomaly identification module 116 which, as will described more fully below, determines whether the KPIs identified in block time series analysis of current from the historical norm. Statistically relevant deviations between the current KPIs and historical norms indicate errant behavior that can be made known at block 118 to support staff, so that appropriate preventative or remedial action can be taken to avoid unwanted consequences, such as a forced outage or the failure of a component.

With continued reference to FIG. 3 and additional reference to FIG. 4, the overall flow logic of a computer-implemented, multidimensional log data anomaly identification method 200 according to embodiments of the present invention will be described. At block 202, the server computer 120 receives a processed activity log data file 600. At block 203, unique messages within the data file 600 are identified, and associated message ID values are assigned to each unique message. At block 204, message sentiment described above is attributed to each unique message ID.

At block 206, the server computer creates a unique message table 700 (shown in FIG. 5) containing the unique messages identified in block 203 (indexed in table 700 by unique message ID), message sentiment attributes generated in 204 for each unique message, and a message category (e.g., Space, Job, or Ping, etc.) for each entry 702 in the unique message table 700.

In block 208, the sever computer 120 distributes the information from the unique message table 700 into the processed data table 600, associating the ID, sentiment, and category attributes that correspond to each unique ID with each occurrence of the various IDs in the processed data. This results in the complete, expanded log data table 800 where each row is a message entry 802 having an expanded set of metadata, including a timestamp, a message ID, message sentiment, and a message category. It is noted that table 800, unlike table 700 which identifies unique messages 702, may have multiple entries 802 with the same message ID attribution, as table 800 represents the entire processed data stream with attributes assigned as appropriate for logged messages, not just a listing of unique messages.

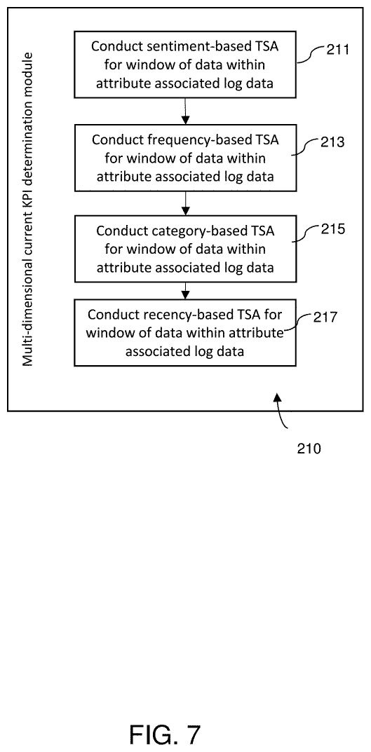

In block 210, the server computer 120 determines log data key performance indicators (KPIs) for messages logged within time intervals, as indicated by timestamp metadata associated with each message. As shown in more detail in FIG. 7, the multi-dimensional current KPI determination module, at block 211 draws timestamped sentiment information from table 800 and conducts a sentiment-based time series analysis for data entries logged within a selected intervals of time (e.g., groups of five minutes). This results in a holistic representation (not shown) of how message tone changes across time intervals. It is noted that individual messages with negative sentiment attributes may also trigger generation of an associated alert or notification. A periodic increase in negative message volume is important to note, because it may, on its own, or in combination with other KPIs, indicate current or upcoming trouble to be addressed.

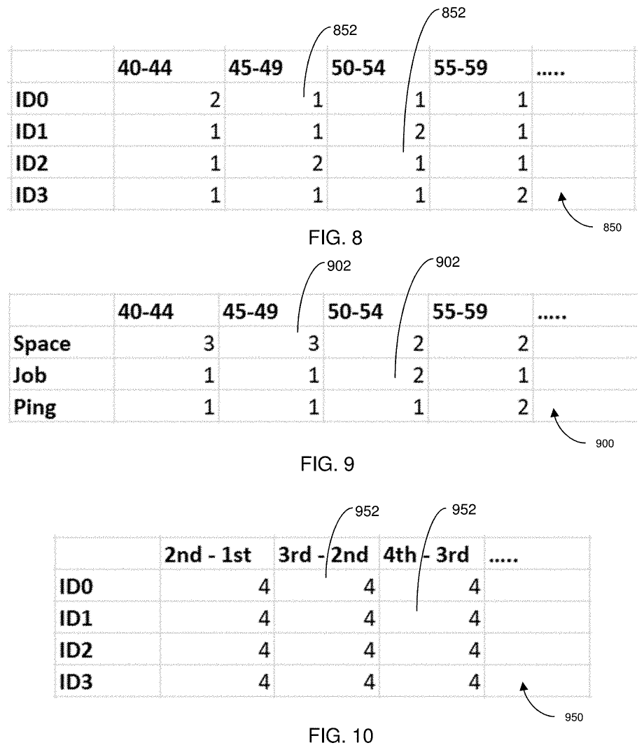

As shown with reference again to FIG. 7, the multi-dimensional current KPI determination module, at block 213 draws timestamped message ID frequency information from table 800 and conducts a message ID frequency-based time series analysis for data entries logged within a selected interval of time. With reference to FIG. 8, each time interval is chosen to be five minutes (40-44, etc.); this value can be adjusted up or down to match overall log volume and capture pace, with shorter intervals being chosen to provide analysis granularity for higher volume and capture pace, with longer intervals selected for applications with lower volume and capture pace. The results of the analysis are recorded as element 852 for each unique ID.

As shown with reference again to FIG. 7, the multi-dimensional current KPI determination module, at block 215 draws timestamped category appearance frequency information from table 800 and conducts a category appearance frequency-based time series analysis for data entries logged within a selected interval of time. With reference to FIG. 9, each time interval is chosen to be five minutes (40-44, etc.); this value can be adjusted up of down to match overall log volume and capture pace, with shorter intervals being chosen to provide analysis granularity for higher volume and capture pace, with longer intervals selected for applications with lower volume and capture pace. The results of the analysis are recorded as element 902 for each message category.

As shown with reference again to FIG. 7, the multi-dimensional current KPI determination module, at block 217 draws recency (e.g., how long between occurrences of a given unique ID or “time difference” between appearances of a unique message ID) information from table 800 and conducts a recency-based time series analysis for data entries logged within a selected interval of time. It is noted that recency attributes may not have timestamps, and that time difference attributes may be directly assigned to appearances of each unique ID. With particular reference to FIG. 10, the time in minutes 952 between each unique log ID occurrence (between 1^{st} and 2^{nd}, between 2^{nd} and 3^{rd}, ect. ) is identified. The results of the analysis are recorded as element 952 for each unique ID.

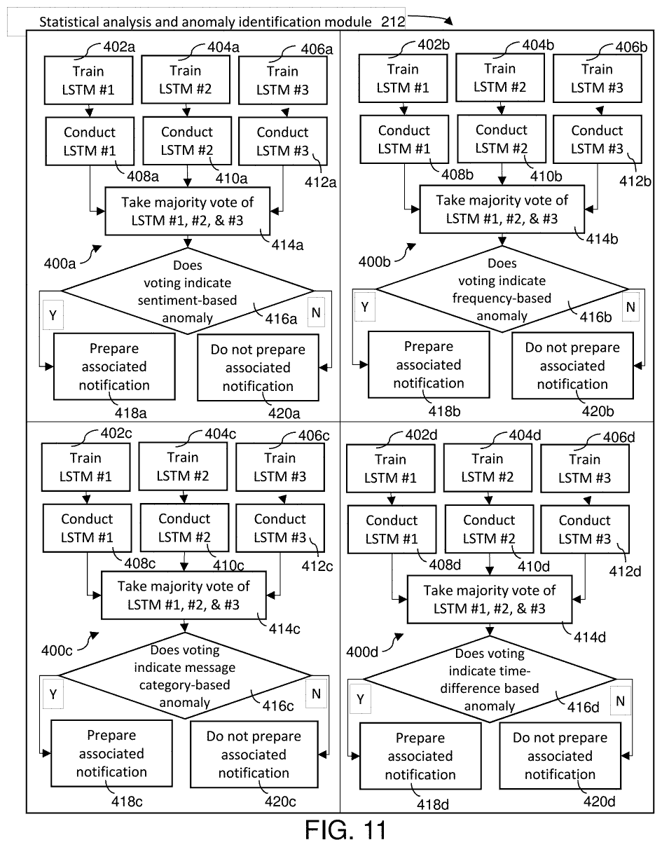

With reference to FIG. 11, the statistical analysis and anomaly identification module 212 will now be described. By way of overview, the analysis and anomaly identification module 212 includes three deep learning models: LSTM with auto-encoders, LSTM with uncertainty estimation, and LSTM with dropout. Each of the three models is applied to the results of the four time series analyses attributes (sentiment, ID frequency, category appearance frequency, and recency) described above.

With continued reference to FIG. 11, the sentiment-based time series analyses results are analyzed as follows. At blocks 402a, 404a, and 406a, the LSTM with auto-encoders, LSTM with uncertainty estimation, and LSTM with dropout (respectively) are trained with normalized historical data for sentiment, in the manner known to those skilled in this field to generate historical baseline for sentiment. Then, at 408a, 410a, and 412a, the trained LSTM with auto-encoders, trained LSTM with uncertainty estimation, and trained LSTM with dropout (respectively) models are applied to the logged sentiment attributes associated with each logged time interval. If, at blocks 414a and 416a, application of two or more trained models indicates a statistically-relevant (as known to those skilled in this field) sentiment-based anomaly, and an associated notification is prepared. If, at blocks 414a and 416a, application of two or more trained models does not indicate a sentiment-based anomaly, no associated notification is prepared.

With continued reference to FIG. 11, the message ID frequency-based time series analyses results are analyzed as follows. At blocks 402b, 404b, and 406b, the LSTM with auto-encoders, LSTM with uncertainty estimation, and LSTM with dropout (respectively) are trained with normalized historical data for sentiment, in the manner known to those skilled in this field to generate historical baseline for sentiment. Then, at 408b, 410b, and 412b, the trained LSTM with auto-encoders, trained LSTM with uncertainty estimation, and trained LSTM with dropout (respectively) models are applied to the logged sentiment attributes associated with each logged time interval. If, at blocks 414b and 416b, application of two or more trained models indicates a statistically-relevant (as known to those skilled in this field) message ID frequency-based anomaly, and an associated notification is prepared. If, at blocks 414b and 416b, application of two or more trained models does not indicate a message ID frequency-based anomaly, no associated notification is prepared.

With continued reference to FIG. 11, the category appearance frequency-based time series analyses results are analyzed as follows. At blocks 402c, 404c, and 406c, the LSTM with auto-encoders, LSTM with uncertainty estimation, and LSTM with dropout (respectively) are trained with normalized historical data for sentiment, in the manner known to those skilled in this field to generate historical baseline for sentiment. Then, at 408c, 410c, and 412c, the trained LSTM with auto-encoders, trained LSTM with uncertainty estimation, and trained LSTM with dropout (respectively) models are applied to the logged sentiment attributes associated with each logged time interval. If, at blocks 414c and 416c, application of two or more trained models indicates a statistically-relevant (as known to those skilled in this field) category appearance frequency-based anomaly, and an associated notification is prepared. If, at blocks 414c and 416c, application of two or more trained models does not indicate a category appearance frequency-based anomaly, no associated notification is prepared.

With continued reference to FIG. 11, the time difference or recency-based time series analyses results are analyzed as follows. At blocks 402d, 404d, and 406d, the LSTM with auto-encoders, LSTM with uncertainty estimation, and LSTM with dropout (respectively) are trained with normalized historical data for sentiment, in the manner known to those skilled in this field to generate historical baseline for sentiment. Then, at 408d, 410d, and 412d, the trained LSTM with auto-encoders, trained LSTM with uncertainty estimation, and trained LSTM with dropout (respectively) models are applied to the logged sentiment attributes associated with each logged time interval. If, at blocks 414d and 416d, application of two or more trained models indicates a statistically-relevant (as known to those skilled in this field) recency-based anomaly, and an associated notification is prepared. If, at blocks 414d and 416d, application of two or more trained models does not indicate a recency-based anomaly, no associated notification is prepared.

After, the trio of deep learning statistical analysis models is applied as described above, in block 210, to each KPI time series, the server computer 120, delivers prepared notifications at block 214. The multi-dimensional analysis of aspects of the invention allows for problems to be identified and alerts delivered to support staff not only due to anomalies within a single indicator, but also for various combinations of factors. For example, when a notification of recency decrease for negative sentiment messages (that is negative messages are occurring more rapidly) is delivered in combination with rise in “Job” category messages, this may indicate a coding issue that is developing but which has not yet caused an outage; this combination could be useful for IT support staff to generate a preventative patch before system failure occurs. show pending storage device failure before it occurs. Delivery of complementary, multi-dimensional KPI trend information allows problems to be identified in a predictive, holistic, manner rather than merely waiting for a single to factor to indicate failure or show why failure has already occurred. It is also useful when no single factor provides a root cause for failure.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

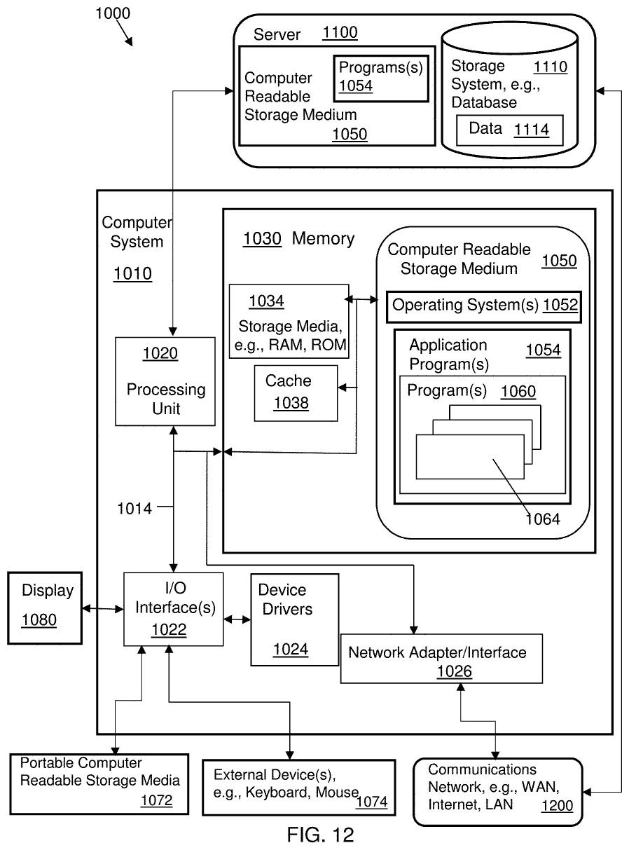

Referring to FIG. 12, a system or computer environment 1000 includes a computer diagram 1010 shown in the form of a generic computing device. The method 100, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure. It is also understood that the control system 70 (shown in FIG. 12) can include all or part of the computer system 1010 and its components, and/or the control system can communicate with all or part of the computer system 1010 and its components as a remote computer system, to achieve the control system functions described in the present disclosure. It is also understood that the one or more communication devices 110 shown in FIG. 1 similarly can include all or part of the computer system 1010 and its components, and/or the communication devices can communicate with all or part of the computer system 1010 and its components as a remote computer system, to achieve the computer functions described in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

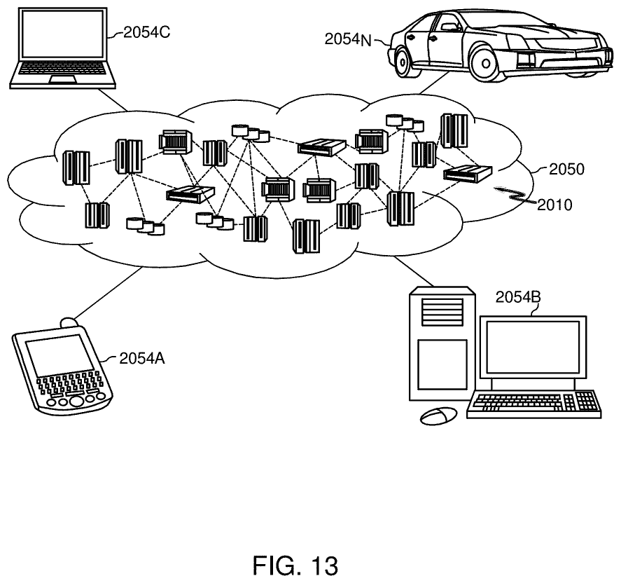

Referring now to FIG. 13, illustrative cloud computing environment 2050 is depicted. As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 13 are intended to be illustrative only and that computing nodes 2010 and cloud computing environment 2050 can communicate with any type of computerized device over any type of network and/or network addressable connection (e.g., using a web browser).

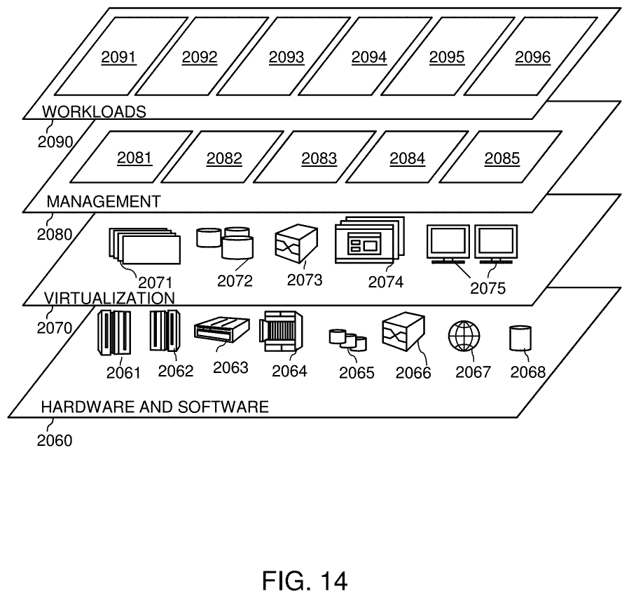

Referring now to FIG. 14, a set of functional abstraction layers provided by cloud computing environment 2050 (FIG. 13) is shown. It should be understood in advance that the components, layers, and functions shown in FIG. 14 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and computer-generated log data anomaly detection 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for identifying anomalies in log data, comprising:
receiving, by a computer, a plurality of discrete log data entries, said plurality having at least one unique entry;
generating, by said computer, a log data sentiment analyzer having a lexicon customized to identify a tone of content for each of said log data entries;
assigning, by said computer, a unique message ID to said at least one unique message;
collecting, by said computer, data attributes of said at least one unique entry, said attributes identifying, for each unique entry, an entry sentiment and at least one additional unique entry attribute; and
conducting, by said computer, statistical analysis of said collected data attributes using at least one deep learning analysis model to identify historical anomalies in said log data attributes,
wherein said identified anomalies indicate trouble associated with said log data.

2. The computer-implemented method of claim 1 further including:
identifying, by said computer, an analysis time window;
conducting, by said computer, for said analysis time window, a time series analysis which identifies a negative count value associated with a quantity of log entries for which said entry sentiment is negative; and
conducting, by said computer, for said analysis time window, a time series analysis which identifies a log data characteristic selected from the group consisting of message occurrence frequency for said at least one unique message, time differences between occurrences of said unique message, and frequency of messages having a predetermined category to determine said at least one additional log data attribute.

3. The computer-implemented method of claim 1, wherein said at least one additional log data attribute is determined by conducting, by said computer, for said analysis time window, a time series analysis which identifies a message occurrence frequency for said at least one unique message, time differences between occurrences of said unique message, and frequency of messages having a predetermined category.

4. The computer-implemented method of claim 1, wherein said at least one deep learning model is selected from the group consisting of LSTM with auto-encoders, LSTM with uncertainty estimation, and LSTM with dropout.

5. The computer-implemented method of claim 1, wherein said at least one deep learning model is LSTM with auto-encoders, LSTM with uncertainty estimation, and LSTM with dropout.

6. A system for identifying anomalies in log data which comprises:
a computer system comprising a computer readable storage medium having program instructions embodied therewith, the program instructions executable by a computer to cause the computer to:
receive a plurality of discrete log data entries, said plurality having at least one unique entry;
generate a log data sentiment analyzer having a lexicon customized to identify a tone of content for each of said log data entries;
assign a unique message ID to said at least one unique message;
collect data attributes of said at least one unique entry, said attributes identifying, for each unique entry, an entry sentiment and at least one additional unique entry attribute; and
conduct statistical analysis of said collected data attributes using at least one deep learning analysis model to identify historical anomalies in said log data attributes, wherein said identified anomalies indicate trouble associated with said log data.

7. The system of claim 6 further including further instructions which cause said computer to:
identify an analysis time window;
conduct for said analysis time window, a time series analysis which identifies a negative count value associated with a quantity of log entries for which said entry sentiment is negative;
and
conduct for said analysis time window, a time series analysis which identifies a log data characteristic selected from the group consisting of message occurrence frequency for said at least one unique message, time differences between occurrences of said unique message, and frequency of messages having a predetermined category to determine said at least one additional log data attribute.

8. The system of claim 6, wherein said at least one additional log data attribute is determined by conducting, by said computer, for said analysis time window, a time series analysis which identifies a message occurrence frequency for said at least one unique message, time differences between occurrences of said unique message, and frequency of messages having a predetermined category.

9. The system of claim 6, wherein said at least one deep learning model is selected from the group consisting of LSTM with auto-encoders, LSTM with uncertainty estimation, and LSTM with dropout.

10. The system of claim 6, wherein said at least one deep learning model is LSTM with auto-encoders, LSTM with uncertainty estimation, and LSTM with dropout.

11. A computer program product to identify anomalies in log data, the computer program product comprising a computer readable storage medium having program instructions embodied therewith, the program instructions executable by a computer to cause the computer to:
receive, using the computer, a plurality of discrete log data entries, said plurality having at least one unique entry;
generate, using the compouter, a log data sentiment analyzer having a lexicon customized to identify a tone of content for each of said log data entries;
assign, using the computer, a unique message ID to said at least one unique message;
collect, using the computer, data attributes of said at least one unique entry, said attributes identifying, for each unique entry, an entry sentiment and at least one additional unique entry attribute; and
conduct, using the computer, statistical analysis of said collected data attributes using at least one deep learning analysis model to identify historical anomalies in said log data attributes, wherein said identified anomalies indicate trouble associated with said log data.

12. The computer program product of claim 11 further including further instructions which cause said computer to:
identify, using the computer, an analysis time window;
conduct, using the computer, for said analysis time window, a time series analysis which identifies a negative count value associated with a quantity of log entries for which said entry sentiment is negative; and
conduct for said analysis time window, a time series analysis which identifies a log data characteristic selected from the group consisting of message occurrence frequency for said at least one unique message, time differences between occurrences of said unique message, and frequency of messages having a predetermined category to determine said at least one additional log data attribute.

13. The computer program product of claim 11, wherein said at least one additional log data attribute is determined by conducting, by said computer, for said analysis time window, a time series analysis which identifies a message occurrence frequency for said at least one unique message, time differences between occurrences of said unique message, and frequency of messages having a predetermined category.

14. The computer program product of claim 11, wherein said at least one deep learning model is selected from the group consisting of LSTM with auto-encoders, LSTM with uncertainty estimation, and LSTM with dropout.

15. The computer program product of claim 11, wherein said at least one deep learning model is LSTM with auto-encoders, LSTM with uncertainty estimation, and LSTM with dropout.
